(19) United States
(12) Patent Application Publication
(10) Pub. No.: US 2023/0216790 A1
(43) Pub. Date: Jul. 6, 2023

(54) APPARATUS AND METHOD FOR PROVIDING VIRTUAL PRIVATE NETWORK SERVICE IN ICN NETWORK

(71) Applicant: ELECTRONICS AND TELECOMMUNICATIONS RESEARCH INSTITUTE, Daejeon (KR)

(72) Inventors: Hak Suh KIM, Daejeon (KR); Nam Seok KO, Daejeon (KR); Sun Me KIM, Daejeon (KR)

(73) Assignee: ELECTRONICS AND TELECOMMUNICATIONS RESEARCH INSTITUTE, Daejeon (KR)

(21) Appl. No.: 17/964,572

(22) Filed: Oct. 12, 2022

(30) Foreign Application Priority Data
Jan. 4, 2022 (KR) 10-2022-0001197

(51) Int. Cl. H04L 45/00; H04L 45/42; H04L 45/745

(52) U.S. Cl. CPC H04L 45/566; H04L 45/42; H04L 45/745

(57) ABSTRACT

According to an embodiment of the present disclosure, there is provided a method for providing a virtual private network service in ICN name-based networking. The method comprising: receiving an interest packet; checking whether or not the interest packet includes a forwarding hint; checking, when the interest packet includes the forwarding hint, whether or not the forwarding hint includes a specific keyword; generating, when the forwarding hint includes the specific keyword, a VRF ID by extracting a VRF name from a name of the interest packet; selecting an FIB by using the generated VRF ID; executing a lookup for the FIB by using an interest name extracted from the interest packet; determining an output port by using the lookup; and transmitting the interest packet to the output port.

### CROSS REFERENCE TO RELATED APPLICATION

The present application claims priority to Korean patent application No. 10-2022-0001197, filed Jan. 4, 2022, the entire contents of which are incorporated herein for all purposes by this reference.

### BACKGROUND OF THE INVENTION

### Field of the Invention

The present disclosure relates to an apparatus and method for providing a virtual private network service, and more particularly, to an apparatus and method for providing a virtual private network service in an ICN network.

### Description of the Related Art

In an IP-based network, a virtual network technology is a technology of providing network virtualization in which a single physical network is configured as a logical network with a plurality of protocols by dividing a single router into a plurality of virtual routing domains. This technology is called virtual routing and forwarding (hereinafter referred to as VRF).

As routing instances are independent from each other, identical or overlapping IP addresses may be used without collision, and as a network path is divided into separate virtual networks by means of a router, network security is enhanced. Such a network virtualization technology enables an Internet service provider to configure a virtual network by providing a separate VPN and thus to accept various services.

In an ICN network, a network virtualization technology is also needed to configure a single physical network as a logical network supporting a plurality of protocols by dividing a single ICN router into a plurality of virtual routing domains.

However, since ICN networks are currently supporting only a single routing domain, the problem is that no network can be virtualized.

### SUMMARY

The present disclosure is directed to provide a method for configuring ICN FIB information, which is logically divided in a single router in order to support network virtualization in an ICN network, and a method for processing a corresponding interest packet.

Other objects and advantages of the present invention will become apparent from the description below and will be clearly understood through embodiments. In addition, it will be easily understood that the objects and advantages of the present disclosure may be realized by means of the appended claims and a combination thereof.

According to an embodiment of the present disclosure, there is provided a method for providing a virtual private network service in ICN name-based networking. The method comprising: receiving an interest packet; checking whether or not the interest packet includes a forwarding hint; checking, when the interest packet includes the forwarding hint, whether or not the forwarding hint includes a specific keyword; generating, when the forwarding hint includes the specific keyword, a VRF ID by extracting a VRF name from a name of the interest packet; selecting an FIB by using the generated VRF ID; executing a lookup for the FIB by using an interest name extracted from the interest packet; determining an output port by using the lookup; and transmitting the interest packet to the output port.

According to the embodiment of the present disclosure, the method further comprising transmitting the interest packet to the output port by executing a lookup for a global FIB, when the interest packet does not include the forwarding hint.

According to the embodiment of the present disclosure, the method further comprising performing general forwarding hint processing, when the forwarding hint does not include the specific keyword.

According to the embodiment of the present disclosure, wherein routing information is stored as an FIB table structure in a space separated according to the VRF ID.

According to the embodiment of the present disclosure, wherein the separated space includes a physically separated space.

According to the embodiment of the present disclosure, wherein the separated space includes a logically separated space.

According to the embodiment of the present disclosure, wherein a VRF name is inserted into a network name part in a name structure of the interest packet.

According to the embodiment of the present disclosure, wherein the VRF name is configured using at least one of a character format, or a numeric format or combination thereof that have a specific arrangement order.

According to the embodiment of the present disclosure, wherein the interest packet includes a forwarding hint, and wherein the forwarding hint includes a specific keyword for executing a VRF table lookup.

According to the embodiment of the present disclosure, the method further comprising selecting a VRF ID by extracting second layer information of the interest packet.

According to another embodiment of the present disclosure, an apparatus for providing a virtual private network service in ICN name-based networking. The apparatus comprising: an input port configured to receive an interest packet; a routing processor configured to: check whether or not the interest packet includes a forwarding hint, check, when the interest packet includes the forwarding hint, whether or not the forwarding hint includes a specific keyword, generate, when the forwarding hint includes the specific keyword, a VRF ID by extracting a VRF name from a name of the interest packet, select an FIB by using the generated VRF ID, execute a lookup for the FIB by using an interest name extracted from the interest packet, and determine a next path by using the lookup, and an output port configured to transmit the interest packet to the next path.

According to another embodiment of the present disclosure, wherein the routing processor is further configured to transmit the interest packet to the output port by executing a lookup for a global FIB, when the interest packet does not include the forwarding hint.

According to another embodiment of the present disclosure, wherein the routing processor is further configured to perform general forwarding hint processing, when the forwarding hint does not include the specific keyword.

According to another embodiment of the present disclosure, the apparatus further comprising a memory configured to store data, wherein the routing processor is further configured to store routing information as an FIB table structure in a space separated according to the VRF ID in the memory.

According to another embodiment of the present disclosure, wherein the separated space includes a physically separated space.

According to another embodiment of the present disclosure, wherein the separated space includes a logically separated space.

According to another embodiment of the present disclosure, wherein the routing processor is further configured to insert a VRF name into a network name part in a name structure of the interest packet.

According to another embodiment of the present disclosure, wherein the VRF name is configured using at least one of a character format, or a numeric format or combination thereof that have a specific arrangement order.

According to another embodiment of the present disclosure, wherein the interest packet includes a forwarding hint, and wherein the forwarding hint includes a specific keyword for executing a VRF table lookup.

According to another embodiment of the present disclosure, an apparatus for providing a virtual private network service in ICN name-based networking. The apparatus comprising: a transceiver configured to receive and transmit an interest packet to a next path; a processor configured to: check whether or not the interest packet includes a forwarding hint, check, when the interest packet includes the forwarding hint, whether or not the forwarding hint includes a specific keyword, generate, when the forwarding hint includes the specific keyword, a VRF ID by extracting a VRF name from a name of the interest packet, select an FIB by using the generated VRF ID, execute a lookup for the FIB by using an interest name extracted from the interest packet, and determine a next path by using the lookup, and a memory configured to store routing information.

The features briefly summarized above with respect to the present disclosure are merely exemplary aspects of the detailed description below of the present disclosure, and do not limit the scope of the present disclosure.

According to an embodiment of the present disclosure, a virtual network may be built up in an ICN network through a network virtualization technology, and as global FIB information is separately configured, users not in the virtual network can also use a service without restriction.

According to an embodiment of the present disclosure, as an existing ICN name structure and an existing packet format are used as they are, compatibility may be provided to another network device.

According to an embodiment of the present disclosure, as a common memory space is used by being divided according to VRF, no additional resource is required.

Effects obtained in the present disclosure are not limited to the above-mentioned effects, and other effects not mentioned above may be clearly understood by those skilled in the art from the following description.

### BRIEF DESCRIPTION OF THE DRAWINGS

FIG. 1 is a view illustrating a configuration of an apparatus for providing a virtual private network service according to an embodiment of the present disclosure.

FIG. 2 is a view illustrating a flowchart of a method for providing a virtual private network service according to an embodiment of the present disclosure.

FIG. 3 is a view illustrating FIB tables separated according to VRF IDs in an IP network according to an embodiment of the present disclosure.

FIG. 4 is a view illustrating an FIB structure of an ICN router according to an embodiment of the present disclosure.

FIG. 5 is a view illustrating a name structure of ICN according to an embodiment of the present disclosure.

FIG. 6 is a view illustrating a structure of a forwarding hint according to an embodiment of the present disclosure.

FIG. 7 is a view illustrating a flowchart of a method for processing an interest packet according to an embodiment of the present disclosure.

FIG. 8 is a view illustrating a method for designating VRF by using second layer information according to an embodiment of the present disclosure.

FIG. 9 is a view illustrating an apparatus for providing a virtual private network service according to an embodiment of the present disclosure.

### DETAILED DESCRIPTION OF THE INVENTION

Hereinafter, exemplary embodiments of the present disclosure will be described in detail with reference to the accompanying drawings so that those skilled in the art may easily implement the present disclosure. However, the present disclosure may be implemented in various different ways, and is not limited to the embodiments described therein.

In describing exemplary embodiments of the present disclosure, well-known functions or constructions will not be described in detail since they may unnecessarily obscure the understanding of the present disclosure. The same constituent elements in the drawings are denoted by the same reference numerals, and a repeated description of the same elements will be omitted.

In the present disclosure, when an element is simply referred to as being “connected to”, “coupled to” or “linked to” another element, this may mean that an element is “directly connected to”, “directly coupled to” or “directly linked to” another element or is connected to, coupled to or linked to another element with the other element intervening therebetween. In addition, when an element “includes” or “has” another element, this means that one element may further include another element without excluding another component unless specifically stated otherwise.

In the present disclosure, elements that are distinguished from each other are for clearly describing each feature, and do not necessarily mean that the elements are separated. That is, a plurality of elements may be integrated in one hardware or software unit, or one element may be distributed and formed in a plurality of hardware or software units. Therefore, even if not mentioned otherwise, such integrated or distributed embodiments are included in the scope of the present disclosure.

In the present disclosure, elements described in various embodiments do not necessarily mean essential elements, and some of them may be optional elements. Therefore, an embodiment composed of a subset of elements described in an embodiment is also included in the scope of the present disclosure. In addition, embodiments including other elements in addition to the elements described in the various embodiments are also included in the scope of the present disclosure.

In the present document, such phrases as ‘A or B’, ‘at least one of A and B’, ‘at least one of A or B’, ‘A, B or C’, ‘at least one of A, B and C’ and ‘at least one of A, B or C’ may respectively include any one of items listed together in a corresponding phrase among those phrases or any possible combination thereof.

Hereinafter, the present disclosure will be described in further detail with reference to the accompanying drawings.

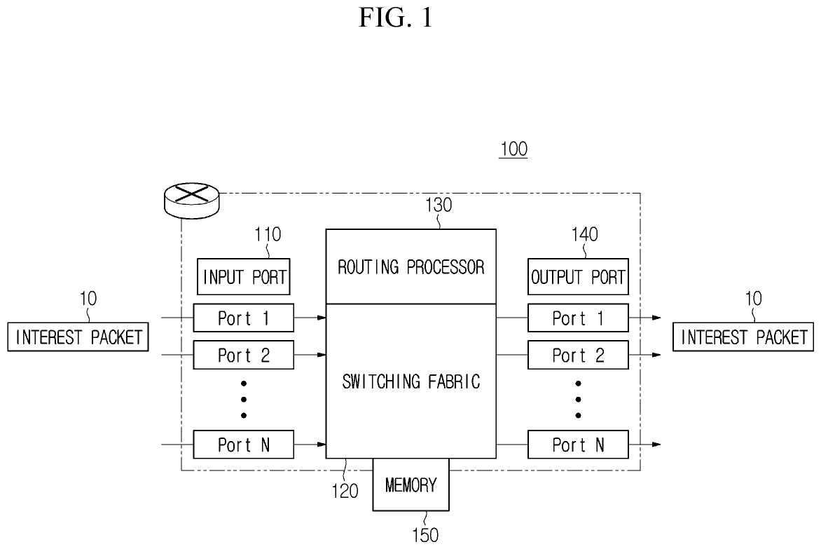

FIG. 1 is a view illustrating a configuration of an apparatus for providing a virtual private network service according to an embodiment of the present disclosure.

Referring to FIG. 1, an apparatus for providing a virtual private network service 100 includes an input port 110, a switching fabric 120, a routing processor 130, an output port 140, and a memory 150.

The apparatus for providing a virtual private network service 100 may be a router.

A router is a device for routing, and routing means a route selection process for systematically determining a method for delivering a message to a destination by using an address in a network.

The input port 110 receives an interest packet 10 from the outside.

The switching fabric 120 means a structure connecting the input port 110 and the output port 140.

The routing processor 130 checks whether or not an interest packet includes a forwarding hint, checks, when the interest packet includes the forwarding hint, whether or not the forwarding hint includes a specific keyword, when the forwarding hint includes the specific keyword, extracts a VRF name of a name of the interest packet and generates a VRF ID, selects an FIB by the generated VRF ID, performs a lookup for the FIB in an interest name extracted from the interest packet, and determines a next path using the lookup.

In case the interest packet does not include the forwarding hint, the routing processor 130 executes a lookup for a global FIB and delivers the interest packet to the output port 140.

When the forwarding hint does not include the specific keyword, the routing processor 130 processes a general forwarding hint.

The routing processor 130 inserts a VRF name into a network name part in a name structure of an interest packet.

The output port 140 outputs the interest packet 10 to the next path.

The memory 150 stores data according to a control command from the routing processor 130.

The routing processor 130 stores routing information as an FIB table structure in a space separated according to the VRF ID in the memory 150.

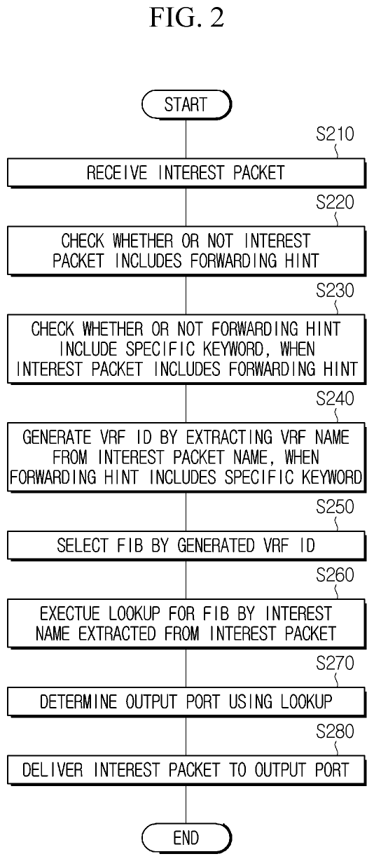

FIG. 2 is a view illustrating a flowchart of a method for providing a virtual private network service according to an embodiment of the present disclosure. The present invention is implemented by an apparatus for providing a virtual private network service.

Referring to FIG. 2, an interest packet is received (S210).

Next, it is checked whether or not the interest packet includes a forwarding hint (S220).

When the interest packet includes the forwarding hint, it is checked whether or not the forwarding hint includes a specific keyword (S230).

When the forwarding hint includes the specific keyword, a VRF ID is generated by extracting a VRF name of a name of the interest packet (S240).

An FIB is selected based on the generated VRF ID (S250).

A lookup for the FIB is performed in an interest name extracted from an interest packet (S260).

An output port is determined using the lookup (S270).

The interest packet is delivered to the output port (S280).

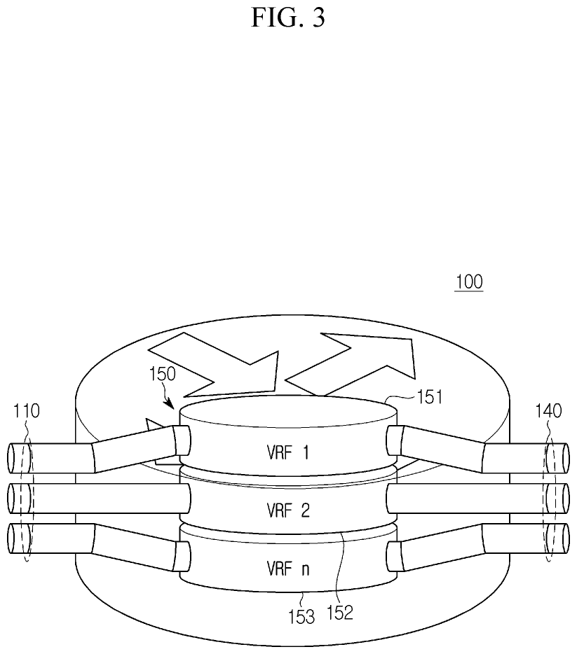

FIG. 3 is a view illustrating FIB tables separated according to VRF IDs in an IP network according to an embodiment of the present disclosure.

In the IP-based router 100, a VRF technology is used for network virtualization. As shown in FIG. 3, the VRF technology configures forwarding tables logically separated in the router 100 and, when packets belonging to different virtual networks arrive the router 100, forwards a packet by using destination information of a forwarding table suitable for each virtual network.

As illustrated in FIG. 3, in an IP router, forwarding information base (FIB) tables separated according to VRF IDs are configured in a single memory space 150 and are used for forwarding.

The router 100 includes the input port 110, the output port 140 and the memory 150. The memory 150 includes VRF 1 151, VRF 2 152, and VRF n 153.

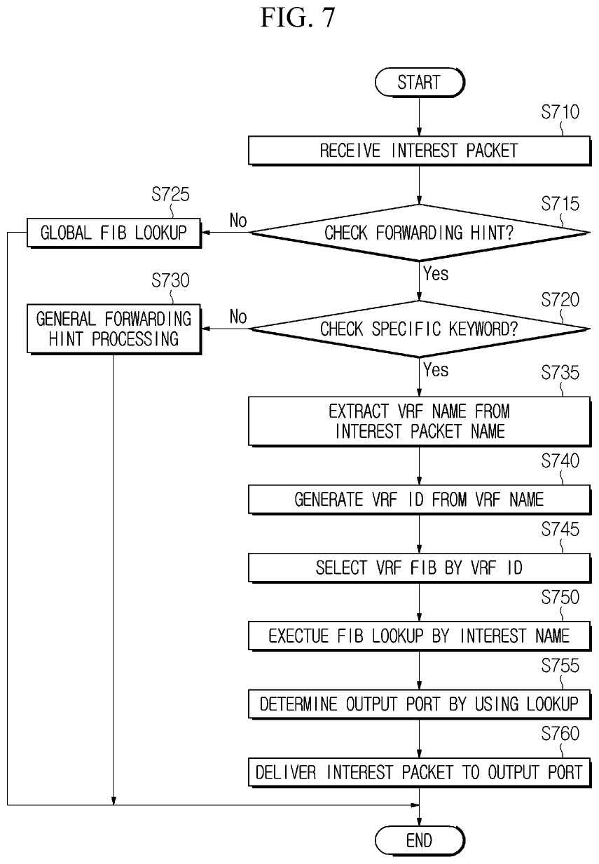

In an ICN router 100, in order to support network virtualization, virtual routing and forwarding information is stored and managed in a separate independent address space for each virtual network, and an interest packet processing method is implemented accordingly. This will be described in FIG. 7 below.

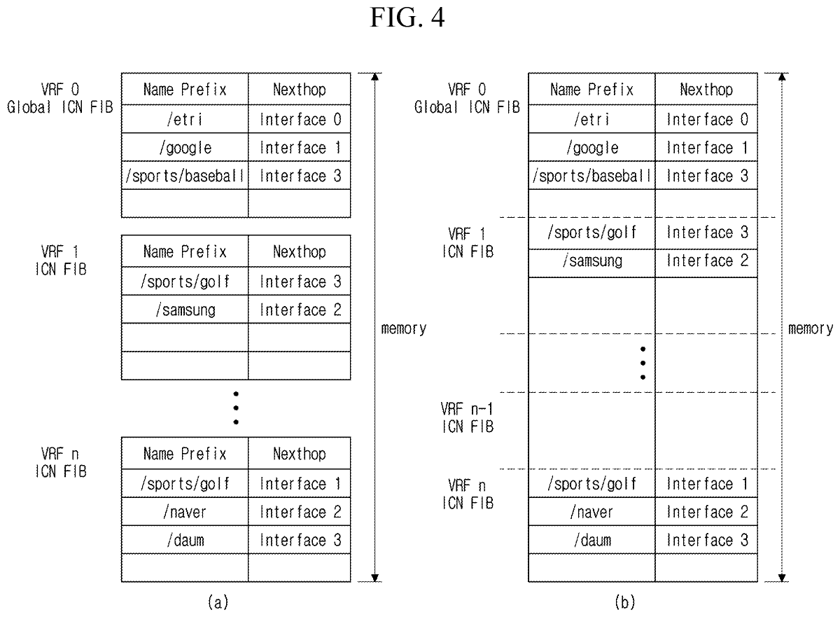

FIG. 4 is a view illustrating an FIB table structure of an ICN router according to an embodiment of the present disclosure. FIG. 4 includes (a) of FIG. 4 and (b) of FIG. 4.

(a) of FIG. 4 is a view illustrating a physically divided FIB table structure.

(b) of FIG. 4 is a view illustrating a logically divided FIB table structure.

Routing information is stored and managed in spaces that are separated according to virtual network configurations, that is, VRFs. As illustrated in (a) of FIG. 4, routing information may be stored in a physically divided memory space. Herein, a discontinuous space means a physically divided space.

As illustrated in (b) of FIG. 4, virtual forwarding information may also be stored in a continuous memory space. The continuous memory space means a space that is logically divided according to VRF IDs.

Specifically, in an ICN network, as a packet is delivered based on a name, routing information is not stored like in the existing IP scheme but may be stored in a memory space based on a hash result value by hashing a name.

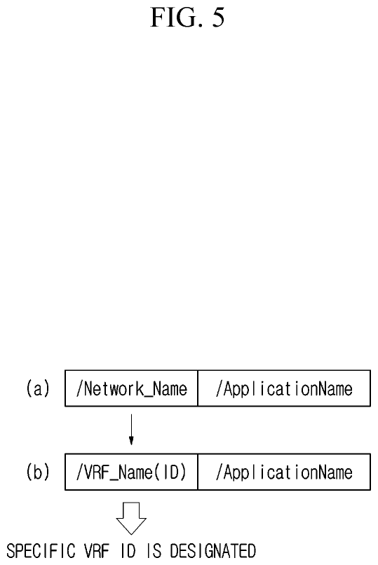

As routing information is divided into each virtual network, the same routing information “/sports/golf” may be present in VRF 1 and VRF n in (a) of FIG. 5, and a path to a destination may be differently designated in each VRF.

For example, in VRF 1 of (a) of FIG. 5, /sports/golf is stored, and a destination is interface 3.

In VRF n of (a) of FIG. 5, /sports/golf is stored, and a destination is interface 1.

As forwarding information is stored by being divided thus, it is possible to construct a complete and logically separate virtual network.

In addition, a global ICN FIB, which does not belong to any virtual network, is generated for name-based forwarding that is the same as the existing scheme. The global ICN FIB manages and uses name routing information, which does not belong to any specific virtual network, to deliver a packet that does not belong to any virtual network.

Global and virtual network name routing information is exchanged through a routing protocol that is operated in an ICN router present in a network. Herein, the routing protocol exchanges routing information according to each VRF ID. Each router manages delivered name routing information according to each VRF ID and stores it in a memory. Accordingly, a VRF ID should be managed not to be duplicate within a single network domain managed by a communication service provider.

In an ICN communication scheme, a consumer sends an interest packet to a producer in order to receive a desired content, and the producer carries the content in a data packet and delivers it to the consumer via a reverse path of the interest packet. Accordingly, if an interest packet can be forwarded in each virtual network, network virtualization may be supported.

FIG. 5 is a view illustrating a name structure of ICN according to an embodiment of the present disclosure. FIG. 5 includes (a) of FIG. 5 and (b) of FIG. 5.

(a) of FIG. 5 is a view illustrating an ICN name structure.

(b) of FIG. 5 is a view illustrating an ICN name structure proposed in the present invention.

Referring to (a) of FIG. 5, an ICN name structure consists of a network name and an application name. An ICN name structure is a structure where a network to which a producer belongs is found by a network name and a content is found by an application name.

As illustrated in (b) of FIG. 5, the present invention proposes a method of inserting a VRF name into the part of a network name.

Herein, the VRF name is configured using at least one of a character format and a numeric format that have a specific arrangement order. Specifically, a VRF name may have a name format that is easy for anyone to read or may be marked in a numeric format like ID.

When receiving an interest packet, an ICN router may find a VRF ID in a VRF name (ID) portion and retrieve a forwarding table belonging to a specific virtual network in which a lookup is to be executed.

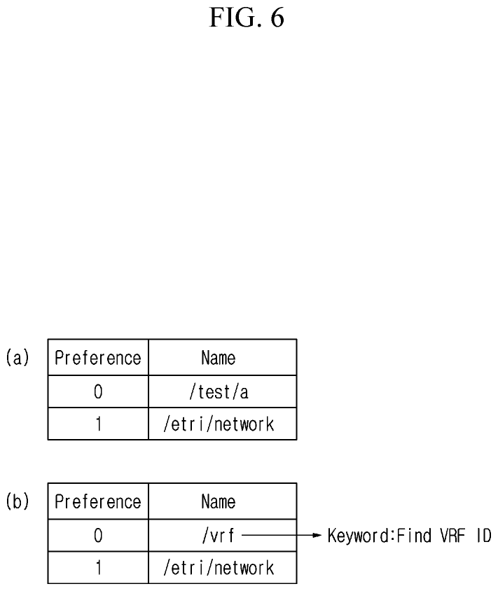

FIG. 6 is a view illustrating a structure of a forwarding hint according to an embodiment of the present disclosure. FIG. 6 includes (a) of FIG. 6 and (b) of FIG. 6.

(a) of FIG. 6 is a view illustrating the structure and usage of a forwarding hint defined in an NDN packet format.

(b) of FIG. 6 is a view illustrating a structure of a forwarding hint proposed in the present invention.

Referring to (a) of FIG. 6, network local information is described along with a preference. When receiving an interest packet including a forwarding hint, a router first executes a lookup on a forwarding table by searching for a name with a highest preference defined in the forwarding hint.

Specifically, preference 0 is higher than preference 1.

Accordingly, /test/a is searched for earlier than /etri/network.

Referring to (b) of FIG. 6, in the present invention, a specific keyword in a forwarding hint is used to indicate a VRF forwarding table lookup. In the present invention, a structure of a forwarding hint is the same as that of a conventional forwarding hint.

As shown in (b) of FIG. 6, an interest packet including a forwarding hint executes a VRF table lookup. For this, a specific keyword is used as a VRF table lookup indicator.

For example, a keyword “/vrf” may be used. However, the present invention is not limited to this keyword and may use various keywords as indicators.

As illustrated in (b) of FIG. 6, an operation of a router receiving an interest packet including a VRF lookup indicator will be described in FIG. 7.

FIG. 7 is a view illustrating a flowchart of a method for processing an interest packet according to an embodiment of the present disclosure. The present invention is implemented by an apparatus for providing a virtual private network service. The apparatus for providing a virtual private network service may be a router.

Referring to FIG. 7, an interest packet is received from an external apparatus (S710).

It is checked whether or not the interest packet includes a forwarding hint (S715).

Specifically, when an ICN router receives the interest packet, it checks whether or not a forwarding hint is present.

When the interest packet includes the forwarding hint, it is checked whether or not the forwarding hint includes a specific keyword (S720).

In case the interest packet does not include the forwarding hint, a lookup for a global FIB is executed and thus the interest packet is delivered to the output port (S725).

Specifically, in case there is no forwarding hint, the interest packet is delivered to a next destination by executing a lookup for the global FIB.

When the forwarding hint does not include the specific keyword, general forwarding hint processing is performed (S730).

Specifically, it is checked whether or not the forwarding hint includes a VRF lookup indicator such as /vrf. In case there is no specific keyword, general forwarding hint processing is performed.

When the forwarding hint includes the specific keyword, a VRF name of a name of the interest packet is extracted (S735).

A VRF ID is generated from the VRF name (S740).

An FIB is selected based on the generated VRF ID (S745).

Specifically, when there is a VRF lookup indicator, the router generates a VRF ID by extracting a VRF name from a name of an interest packet.

Herein, the VRF ID may be extracted from the VRF name, or in case it is an ID, it may be used as it is. The VRF ID thus obtained from such a process is used to select a forwarding table in which a lookup is to be executed. An ID extracted from a name is used to search for a memory space in which routing information is stored.

A lookup for the FIB is performed in an interest name extracted from an interest packet (S750).

An output port is determined using the lookup (S755).

The interest packet is delivered to the output port (S760).

Specifically, a lookup is executed by extracting a name of an interest packet received to obtain a name for a lookup of a virtual forwarding table. By determining an interface to deliver a packet through a lookup operation, the packet is delivered to a next path.

A processing operation for an interest packet is the same as an existing packet processing operation of ICN. Accordingly, a packet delivered to a next destination after finishing a lookup is generated as an entry of a PIT and then, when a data packet arrives, is delivered to a consumer, which requests an initial content, based on PIT information.

Herein, the PIT table includes information on a name of an interest packet and regarding in which interface it is.

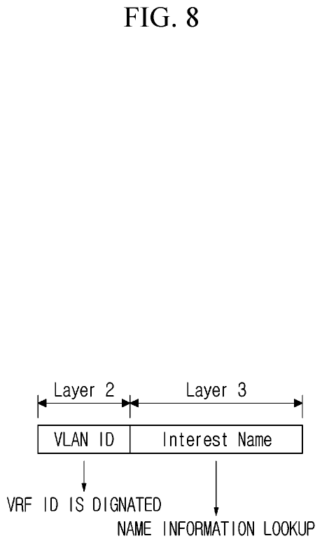

FIG. 8 is a view illustrating a method for designating VRF by using second layer information according to an embodiment of the present disclosure.

Referring to FIG. 8, in an initial entry ICN router to which a consumer node is being connected, a VRF ID may be selected by extracting Layer 2 information of a consumer packet.

In this case, a VLAN ID may be used as it is, or a value hashed through a hash function may be used. Virtual forwarding information may be selected using a VRF ID extracted from Layer 2 information of a received interest packet, and the packet may be delivered to a destination by executing a lookup for name routing information. A virtual forwarding table (VRF) may also be selected by using a VLAN ID that is not NDN network layer information but link layer information. A VRF may be selected based on various information of the received packet.

Layer 3 includes interest name information.

Hereinafter, encryption of contents will be described.

When a malicious user generates and sends an interest packet identical with a packet of a normal user, a desired content may be received by an NDN-based operation. In an NDN network environment to which a caching function is basically provided, such a problem is difficult to prevent at the network side. Accordingly, an important content needs to be transmitted after being encrypted, and a normal user obtains an encryption key in a separate manner and decodes and uses the received content.

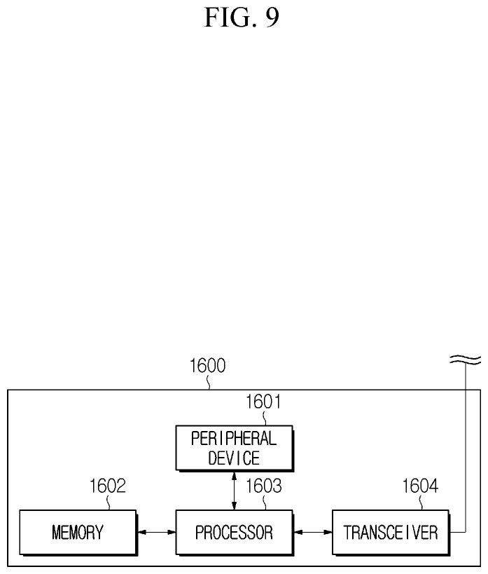

FIG. 9 is a view illustrating an apparatus for providing a virtual private network service according to an embodiment of the present disclosure.

The apparatus for providing a virtual private network service according to an embodiment of the present disclosure may be a device 1600 of FIG. 9. Referring to FIG. 9, the device 1600 may include a memory 1602, a processor 1603, a transceiver 1604 and a peripheral device 1601. In addition, for example, the device 1600 may further include another configuration and is not limited to the above-described embodiment. Herein, for example, the device 1600 may be a mobile user terminal (e.g., a smartphone, a laptop, a wearable device, etc.) or a fixed management device (e.g., a server, a PC, etc.).

More specifically, the device 1600 of FIG. 9 may be an exemplary hardware/software architecture such as a NDN device, NDN server and a content router. Herein, as an example, the memory 1602 may be a non-removable memory or a removable memory. In addition, as an example, the peripheral device 1601 may include a display, GPS or other peripherals and is not limited to the above-described embodiment.

In addition, as an example, like the transceiver 1604, the above-described device 1600 may include a communication circuit. Based on this, the device 1600 may perform communication with an external device.

In addition, as an example, the processor 1603 may be at least one of a general-purpose processor, a digital signal processor (DSP), a DSP core, a controller, a micro controller, application specific integrated circuits (ASICs), field programmable gate array (FPGA) circuits, any other type of integrated circuit (IC), and one or more microprocessors related to a state machine. In other words, it may be a hardware/software configuration playing a controlling role for controlling the above-described device 1600.

Herein, the processor 1603 may execute computer-executable commands stored in the memory 1602 in order to implement various necessary functions of the table service recommendation device. As an example, the processor 1603 may control at least any one operation among signal coding, data processing, power controlling, input and output processing, and communication operation. In addition, the processor 1603 may control a physical layer, an MAC layer and an application layer. In addition, as an example, the processor 1603 may execute an authentication and security procedure in an access layer and/or an application layer but is not limited to the above-described embodiment.

In addition, as an example, the processor 1603 may perform communication with other devices via the transceiver 1604. As an example, the processor 1603 may execute computer-executable commands so that the apparatus for providing a virtual private network service may be controlled to perform communication with other devices via a network. That is, communication performed in the present invention may be controlled. As an example, the transceiver 1604 may send a RF signal through an antenna and may send a signal based on various communication networks.

In addition, as an example, MIMO technology and beam forming technology may be applied as antenna technology but are not limited to the above-described embodiment. In addition, a signal transmitted and received through the transceiver 1604 may be controlled by the processor 1603 by being modulated and demodulated, which is not limited to the above-described embodiment.

While the exemplary methods of the present disclosure described above are represented as a series of operations for clarity of description, it is not intended to limit the order in which the steps are performed, and the steps may be performed simultaneously or in different order as necessary. In order to implement the method according to the present disclosure, the described steps may further include other steps, may include remaining steps except for some of the steps, or may include other additional steps except for some of the steps.

The various embodiments of the present disclosure are not a list of all possible combinations and are intended to describe representative aspects of the present disclosure, and the matters described in the various embodiments may be applied independently or in combination of two or more.

In addition, various embodiments of the present disclosure may be implemented in hardware, firmware, software, or a combination thereof. In the case of implementing the present invention by hardware, the present disclosure can be implemented with application specific integrated circuits (ASICs), Digital signal processors (DSPs), digital signal processing devices (DSPDs), programmable logic devices (PLDs), field programmable gate arrays (FPGAs), general processors, controllers, microcontrollers, microprocessors, etc.

The scope of the disclosure includes software or machine-executable commands (e.g., an operating system, an application, firmware, a program, etc.) for enabling operations according to the methods of various embodiments to be executed on an apparatus or a computer, a non-transitory computer-readable medium having such software or commands stored thereon and executable on the apparatus or the computer.

What is claimed is:

1. A method for providing a virtual private network service in ICN name-based networking, the method comprising:
receiving an interest packet;
checking whether or not the interest packet includes a forwarding hint;
checking, when the interest packet includes the forwarding hint, whether or not the forwarding hint includes a specific keyword;
generating, when the forwarding hint includes the specific keyword, a VRF ID by extracting a VRF name from a name of the interest packet;
selecting an FIB by using the generated VRF ID;
executing a lookup for the FIB by using an interest name extracted from the interest packet;
determining an output port by using the lookup; and
transmitting the interest packet to the output port.

2. The method of claim 1, further comprising transmitting the interest packet to the output port by executing a lookup for a global FIB, when the interest packet does not include the forwarding hint.

3. The method of claim 1, further comprising performing general forwarding hint processing, when the forwarding hint does not include the specific keyword.

4. The method of claim 1, wherein routing information is stored as an FIB table structure in a space separated according to the VRF ID.

5. The method of claim 4, wherein the separated space includes a physically separated space.

6. The method of claim 4, wherein the separated space includes a logically separated space.

7. The method of claim 1, wherein a VRF name is inserted into a network name part in a name structure of the interest packet.

8. The method of claim 7, wherein the VRF name is configured using at least one of a character format, or a numeric format or combination thereof that have a specific arrangement order.

9. The method of claim 1, wherein the interest packet includes a forwarding hint, and
wherein the forwarding hint includes a specific keyword for executing a VRF table lookup.

10. The method of claim 1, further comprising selecting a VRF ID by extracting second layer information of the interest packet.

11. An apparatus for providing a virtual private network service in ICN name-based networking, the apparatus comprising:
an input port configured to receive an interest packet;
a routing processor configured to:
check whether or not the interest packet includes a forwarding hint,
check, when the interest packet includes the forwarding hint, whether or not the forwarding hint includes a specific keyword,
generate, when the forwarding hint includes the specific keyword, a VRF ID by extracting a VRF name from a name of the interest packet,
select an FIB by using the generated VRF ID,
execute a lookup for the FIB by using an interest name extracted from the interest packet, and
determine a next path by using the lookup, and
an output port configured to transmit the interest packet to the next path.

12. The apparatus of claim 11, wherein the routing processor is further configured to transmit the interest packet to the output port by executing a lookup for a global FIB, when the interest packet does not include the forwarding hint.

13. The apparatus of claim 11, wherein the routing processor is further configured to perform general forwarding hint processing, when the forwarding hint does not include the specific keyword.

14. The apparatus of claim 11, further comprising a memory configured to store data,
wherein the routing processor is further configured to store routing information as an FIB table structure in a space separated according to the VRF ID in the memory.

15. The apparatus of claim 14, wherein the separated space includes a physically separated space.

16. The apparatus of claim 14, wherein the separated space includes a logically separated space.

17. The apparatus of claim 11, wherein the routing processor is further configured to insert a VRF name into a network name part in a name structure of the interest packet.

18. The apparatus of claim 17, wherein the VRF name is configured using at least one of a character format, or a numeric format or combination thereof that have a specific arrangement order.

19. The apparatus of claim 11, wherein the interest packet includes a forwarding hint, and
wherein the forwarding hint includes a specific keyword for executing a VRF table lookup.

20. An apparatus for providing a virtual private network service in ICN name-based networking, the apparatus comprising:
a transceiver configured to receive and transmit an interest packet to a next path;
a processor configured to:
check whether or not the interest packet includes a forwarding hint,
check, when the interest packet includes the forwarding hint, whether or not the forwarding hint includes a specific keyword,
generate, when the forwarding hint includes the specific keyword, a VRF ID by extracting a VRF name from a name of the interest packet,
select an FIB by using the generated VRF ID,
execute a lookup for the FIB by using an interest name extracted from the interest packet, and
determine a next path by using the lookup, and
a memory configured to store routing information.
